(19) United States
(12) Patent Application Publication
(10) Pub. No.: US 2015/0202700 A1
(43) Pub. Date: Jul. 23, 2015

(54) METHOD OF CUTTING HIGH-HARDNESS MATERIAL WITH MULTI-WIRE SAW

(71) Applicant: Hitachi Metals, Ltd., Tokyo (JP)

(72) Inventors: Sadahiko KONDO, Mishima-gun (JP); Akira MIYACHI, Mishima-gun (JP)

(21) Appl. No.: 14/596,453

(22) Filed: Jan. 14, 2015

(30) Foreign Application Priority Data
Jan. 17, 2014 (JP) 2014-006791

(51) Int. Cl. B23D 61/18; B28D 1/08

(52) U.S. Cl. CPC B23D 61/185; B28D 1/08

(57) ABSTRACT

In a method of cutting a high-hardness material with a multi-wire saw, an ingot of the high-hardness material is sliced into a plurality of wafers by cutting the ingot at multiple points simultaneously with the multi-wire saw. The method comprises repeating a run cycle of reciprocating motion of a wire of the multi-wire saw so that the relationships (1) c1≧20, given C1=b/a and (2) 0.35≦c2≦1.55, given c2=d/a are satisfied, where a is a maximum total contact length defined as a sum of the lengths of the ingot as projected onto multiple cut points when projecting the ingot onto the wire in a direction in which the ingot is going to be cut, b is a continuous travel distance of the wire, and d is a length of the wire newly fed in each said run cycle.

### BACKGROUND

1. Technical Field

The present disclosure relates to a method of cutting a high-hardness material with a multi-wire saw.

2. Description of the Related Art

Recently, silicon carbide semiconductors have attracted a lot of attention as a new type of semiconductor materials. Silicon carbide semiconductors have a greater dielectric breakdown voltage, a higher electron saturated drift velocity, and a higher thermal conductivity than silicon semiconductors. For that reason, researches and developments have been carried on extensively to realize, using those silicon carbide semiconductors, power devices which can operate at higher temperatures, at higher speeds and with a larger amount of current supplied than conventional silicon devices. Among other things, since motors for use in electric motorcycles, electric cars and hybrid cars are either AC driven or inverter-controlled, development of high-efficiency switching elements for use in those applications is desired. To realize such a power device, a single-crystal silicon carbide wafer is needed to grow epitaxially a silicon carbide semiconductor layer of quality thereon.

Gallium nitride has also been researched extensively as a semiconductor material that would realize power devices and high-luminance light-emitting elements. Thus, there is a growing demand for a wafer of a high-hardness semiconductor material such as gallium nitride and a wafer of high-hardness sapphire for use to form a gallium nitride semiconductor layer.

Generally speaking, a wafer of a semiconductor material needs to be machined with high accuracy. However, compared to silicon wafers which are currently being mass-produced and used extensively, it is far more difficult to cut such a high-hardness material with high machining accuracy and finish it into a wafer with a high degree of planarity. For that reason, techniques for machining a high-hardness material using a multi-wire saw with high accuracy have also been researched.

For example, Japanese Laid-Open Patent Publication Nos. 2009-184023 and 2009-262305 (hereinafter, referred to as Patent Documents Nos. 1 and 2, respectively) disclose a technique for cutting a single-crystal ingot of sapphire with a multi-wire saw with waving and warp of the wafer reduced. Specifically, Patent Document No. 1 discloses a technique for reducing the wafer's waving and increasing the degree of symmetry by cutting the ingot with the wires run back and forth in short cycles. Patent Document No. 2 discloses a technique for reducing a cut face's waving by running the wires parallel to an a-plane in cutting a single-crystal sapphire wafer, of which the principal surface is an r-plane.

### SUMMARY

The present inventors studied the techniques disclosed in Patent Documents Nos. 1 and 2 thoroughly, and discovered that the wafer's warp could not be reduced sufficiently by the techniques disclosed in Patent Documents Nos. 1 and 2. Thus, the present discloses provides a method of cutting a high-hardness material with a multi-wire saw which contributes to manufacturing wafers of a high-hardness material with higher machining accuracy.

In a method of cutting a high-hardness material with a multi-wire saw according to the present disclosure, an ingot of the high-hardness material is sliced into a plurality of wafers by cutting the ingot at multiple points simultaneously with the multi-wire saw. The method comprises repeating a run cycle of reciprocating motion of a wire of the multi-wire saw so that following relationships are satisfied:

c1≧20, given C1=b/a,

where
a is a maximum total contact length defined as a sum of the lengths of the ingot as projected onto multiple cut points when projecting the ingot onto the wire in a direction in which the ingot is going to be cut, and b is a continuous travel distance of the wire; and

0.35≦c2≦1.55, given c2=d/a,

where
d is a length of the wire newly fed in each said run cycle.

The run cycle may be repeated so that the following Inequality is satisfied:

20≦c1≦80.

The run cycle may be repeated so that the following Inequalities are satisfied:

65≦c1≦115 and

0.6≦c2≦1.

c1 and c2 may satisfy the relation 30≦c1×c2≦115.

c1 and c2 may satisfy the relation 50≦c1≦×c2≦90.

Super abrasive particles may be fixed on the wire by electrodeposition.

The high-hardness material may have a Vickers hardness of 1500 or more.

The high-hardness material may be selected from the group consisting of silicon carbide, sapphire, gallium nitride, aluminum nitride, diamond, boron nitride, zinc oxide, gallium oxide and titanium dioxide.

The ingot's crystal lattice may have at least one cleaved face, the wafers sliced off from the ingot may each have a principal surface, and the wire may be run in a direction which is non-parallel to an intersection between the principal surface and the cleaved face.

The high-hardness material may have a hexagonal system crystal structure, the ingot's principal surface may be an r-plane, and the at least one cleaved face may be a c-plane.

The high-hardness material may be sapphire, the principal surface may be a c-plane, and the at least one cleaved face may be an m-plane.

According to the present disclosure, by repeatedly making a run cycle in which the wire is moved back and forth to a continuous travel distance that is 20 times or more as long as the maximum total contact length between a given ingot and the wire, the work of the wire in contact with the ingot can be both reduced and averaged compared to conventional techniques. In addition, the waving or warp of multiple wafers to be sliced off from the ingot can be reduced. On top of that, by setting the length of the wire newly fed in a run cycle to be 0.35 to 1.55 times as large as the maximum total contact length, the wire can be kept sharp enough for a long time. Furthermore, wire snapping can be minimized while the ingot is being cut.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1A is a schematic perspective view illustrating an exemplary multi-wire sawing machine for use in an embodiment of the present disclosure.

FIG. 1B illustrates a wire wound over two rollers of the multi-wire sawing machine shown in FIG. 1A.

FIG. 1C illustrates a cross section of the wire.

FIG. 2 is a schematic perspective view illustrating another exemplary multi-wire sawing machine for use in an embodiment of the present disclosure.

FIG. 3 is a schematic representation illustrating a cross section of an ingot.

FIG. 4A is a schematically shows how the travel velocity of the wire changes with time in a method according to an embodiment.

FIG. 4B schematically shows how the travel velocity of a wire changes with time in a conventional method.

FIG. 5A illustrates the relative arrangement of c-, m- and r-planes in a hexagonal crystal system.

FIG. 5B illustrates the relative arrangement of the c- and m-planes as viewed along a normal to the r-plane.

FIG. 5C illustrates the relative arrangement of the r- and m-planes as viewed along a normal to the c-plane.

FIG. 5D illustrates the relative arrangement of the c-, m- and r-planes as viewed parallel to the intersection between the r- and c-planes.

FIG. 6A Shows a relation, as viewed from the r-plane, between the direction in which the wire suitably runs and the crystal plane of an ingot in a situation where wafers, of which the principal surface is an r-plane, are being sliced off from the ingot, of which the principal surface is also an r-plane.

FIG. 6B Shows a relation, as viewed along a normal to the r-plane, between the direction in which the wire suitably runs and the crystal plane of an ingot in a situation where wafers, of which the principal surface is an r-plane, are being sliced off from the ingot, of which the principal surface is also an r-plane.

FIG. 7 is a graph drawn with the c1×c2 values of Examples and Comparative Examples plotted as abscissas and with the warp of the wafers plotted as ordinates.

### DETAILED DESCRIPTION

Semiconductor devices which use a semiconductor material such as silicon carbide or gallium nitride have just been put on the market as commercial products, and therefore, wafers on which those semiconductor devices are to be fabricated should be manufactured at as low a cost as possible. For that purpose, the material cost per wafer should be cut down by slicing wafers from a high-hardness material as thinly as possible or the overall manufacturing cost should be reduced by slicing those wafers with as high machining accuracy as possible and shortening the time it takes to finish those wafers.

Thus, to meet these demands, the present inventors invented a novel method of cutting a high-hardness material with a multi-wire saw, embodiments of which will be described in detail.

In a method of cutting a high-hardness material with a multi-wire saw according to this embodiment, an ingot of a high-hardness material is cut at multiple points simultaneously with a multi-wire saw which uses a wire. In this description, the “multi-wire saw” refers herein to a machine to cut a given ingot and the “wire” refers herein to a sawing wire.

Examples of the high-hardness materials to be used in the cutting method of this embodiment include silicon carbide, sapphire, gallium nitride, aluminum nitride, diamond, boron nitride, zinc oxide, gallium oxide and titanium dioxide, each of which has a Vickers hardness of 1500 or more. The high-hardness material may be either a single crystalline material or a polycrystalline material. Also, the cutting method of this embodiment can be used effectively to cut an ingot of a high-hardness material which has at least one cleaved face besides a crystallographic plane to be the principal surface of a wafer.

Although the diameter and length of an ingot of the high-hardness material are not particularly limited, wafers of a large diameter and with little warp can be manufactured according to the cutting method of this embodiment. For example, the cutting method of this embodiment can be used effectively to manufacture wafers with a diameter of 4 inches or more. The thickness of the wafers sliced off is not particularly limited, either. According to the cutting method of this embodiment, wafers with a small thickness and with significantly reduced warp can be manufactured. The method of this embodiment can be used particularly effectively to manufacture wafers with a thickness of 300 μm to 1000 μm.

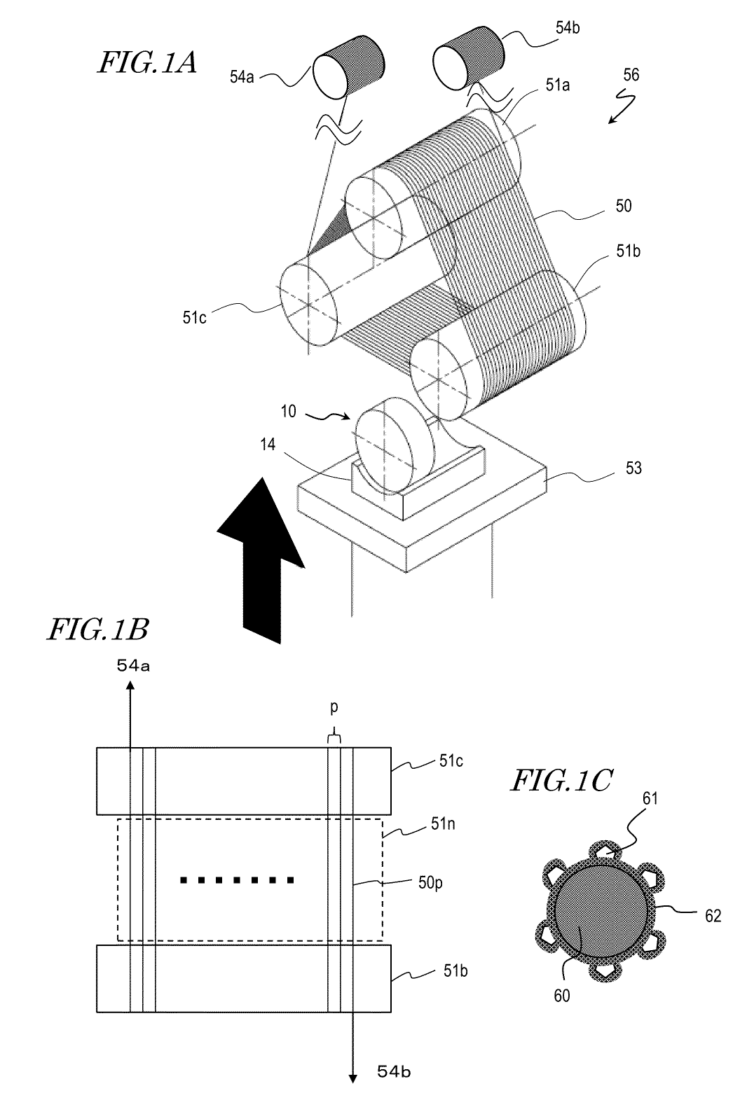

First of all, a multi-wire saw for use in the method of this embodiment will be described. In this embodiment, a multi-wire saw with any of various configurations can be used. FIG. 1A schematically illustrates a multi-wire saw 56 with three rollers. Specifically, the multi-wire saw 56 includes rollers 51a, 51b and 51c and a single continuous wire 50. A high-hardness material ingot 10 is supported on a fixing base 14.

These rollers 51a, 51b and 51c are arranged with a predetermined gap left between them so that their axes of rotation are parallel to each other and are located at the respective vertices of a triangle on a plane which intersects with their axes of rotation at right angles. A number of grooves have been cut on the side surface of each of these rollers 51a, 51b and 51c.

The wire 50 is sequentially wound around those grooves of the rollers 51a, 51b and 51c. FIG. 1B schematically illustrates the wire 50 which is wound a number of times over the rollers 51b and 51c. By bridging the gap between the rollers 51b and 51c once, one cutting part 50p is formed. And a number of such cutting parts 50p are arranged at a constant pitch p corresponding to that of the grooves. Those cutting parts 50p together form a cutting wire web 51n.

Both ends of the wire 50 may be wound around supply/take-up spools 54a and 54b. Although these supply/take-up spools 54 and 54b are arranged close to the roller 51a in the example illustrated in FIG. 1A for the sake of simplicity, the supply/take-up spools 54a and 54b may also be arranged distant from the rollers 51a, 51b and 51c. Optionally, to make the wire 50 run with good stability or to arrange the wire 50 at an intended position, the multi-wire saw 56 may further include additional guide rollers or pulleys.

At the time of cut-grinding process, the supply/take-up spools 54a and 54b and the rollers 51a, 51b and 51c rotate to have one of the supply/take-up spools 54a and 54b collect the wire 50 used. The direction of rotation of the supply/take-up spools 54a and 54b and the rollers 51a, 51b and 51c depends on their arrangement and how to wind the wire 50 over them. In the multi-wire saw 56 shown in FIG. 1A, the rollers 51a, 51b and 51c rotate in the same direction and the supply/take-up spools 54a and 54b rotate in mutually opposite directions.

When the wire 50 used is collected to a predetermined length by one of the supply/take-up spools, the direction of rotation of the supply/take-up spools 54a and 54b and the rollers 51a, 51b, and 51c is reversed. As a result, the wire 50 starts to move in the reverse direction and eventually gets collected by the other of the supply/take-up spools 54a and 54b. By getting this done repeatedly, the wire 50 reciprocates (i.e., moves back and forth).

By moving at least one of the ingot 10 and the cutting wire web 51n formed by the wire 50 between the rollers 51b and 51c with an abrasive slurry supplied onto the cutting wire web 51n, the ingot 10 is pushed against the cutting wire web 51n, thereby getting the ingot 10 sliced by respective cutting parts 50p of the cutting wire web 50n. As a result, the ingot 10 is cut at multiple points at the same time and gets sliced into a huge number of wafers. As shown in FIG. 1A, the multi-wire saw 56 of this type generally slices the ingot 10 supported on the fixing base 14 by pushing the ingot 10 upward against the wire web 50n as indicated by the solid bold arrow.

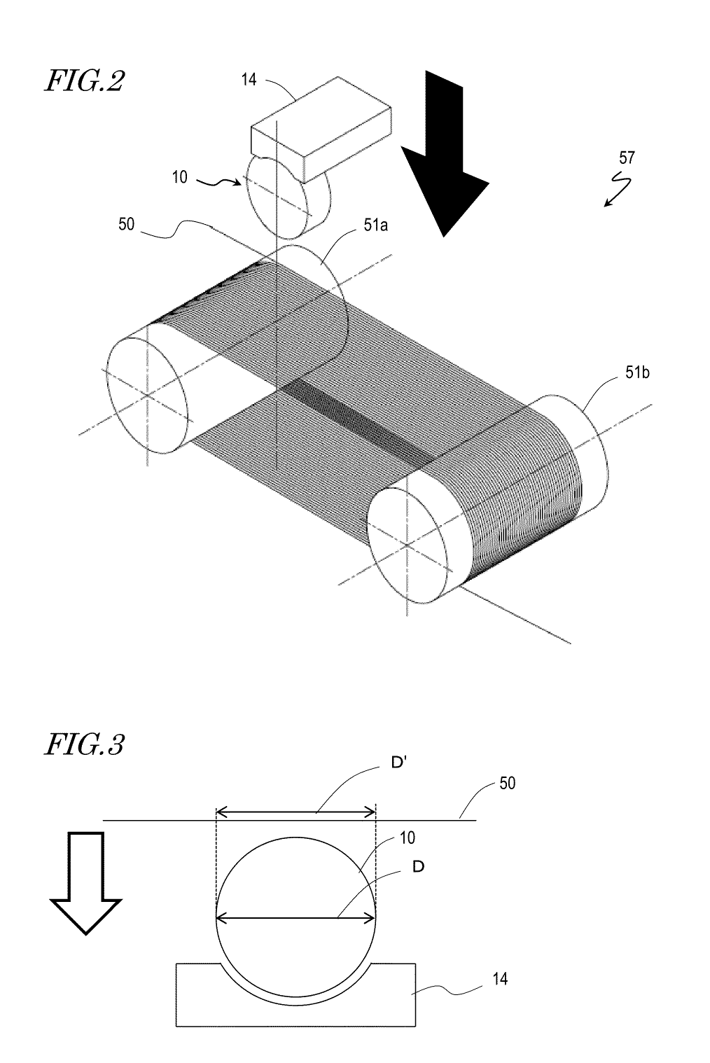

FIG. 2 schematically illustrates a multi-wire saw 57 with two rollers. This multi-wire saw 57 includes rollers 51a and 51b and a wire 50 which is wound a number of times over the rollers 51a and 51b. The wire 50 forms a cutting wire web 51n, where multiple cutting parts 50p are arranged at regular intervals, between the rollers 51a and 51b. The ingot 10 gets sliced at multiple points simultaneously into a huge number of wafers by that cutting wire web 51n formed by the wire 50 between the rollers 51a and 51b. As shown in FIG. 2, the multi-wire saw 57 of this type generally slices the ingot 10 supported on the fixing base 14 by pushing the ingot 10 downward against the wire web 51n as indicated by the solid bold arrow.

As the wire 50, an abrasive-particle-fixed wire may be used, for example. Specifically, a wire in which high-hardness abrasive particles that are suitably used to cut a high-hardness material are electrodeposited on a core may be used. Such high-hardness abrasive particles are also called “super abrasive particles”. FIG. 1C schematically illustrates a cross section of the wire 50. The wire 50 includes a core 60, abrasive particles 61 deposited on the side surface of the core 60, and a plating layer 62, which may be made of Ni, for example. The abrasive particles 61 are located on the surface of the core 60. By covering not only the surface of the core 60 around the abrasive particles 61 but also the abrasive particles 61 themselves with the plating layer 62, the abrasive particles 61 are fixed on the core 60.

Next, it will be described specifically what condition is imposed on the method of cutting a high-hardness material with a multi-wire saw. Suppose, in one run cycle (one unit run cycle) of the wire 50 running back and forth, its forward travel distance is b_{f} and its backward travel distance is b_{b}. If the forward and backward travel distances b_{f} and b_{b} were equal to each other (i.e., if b_{f}=b_{b}), then the ingot 10 would be always cut with the same part of the wire 50 and no virgin part of the wire 50 would be used to cut the ingot 10, no matter how many times the wire 50 runs back and forth. As a result, as the cutting process advances, the wire 50 would get less and less sharp in that case.

Thus, to minimize such a decrease in the sharpness of the wire 50 and to keep the machining accuracy constant no matter how many times the wire 50 runs back and forth, b_{f} and b_{b} are set to be different from each other so that a virgin part of the wire 50 will be used in either every run cycle or every predetermined number of runs. Specifically, the reciprocating movement of the wire 50 is defined so that either b_{f}>b_{b} or b_{f}<b_{b} is satisfied. In that case, a virgin part of the wire 50 will be used for cutting by b_{f}−b_{b} (or b_{b}−b_{f}) in every run cycle, and therefore, the machine accuracy can be kept constant, no matter how many times the wire 50 runs back and forth.

In this description, in a run cycle of the wire 50 running back and forth, the longer travel distance is defined to be the forward route (i.e., b_{f}>b_{b}) and (b_{f}+b_{b})/2 is defined to be the wire's continuous travel distance b. Also, the length of a virgin part of the wire 50 newly fed in a run cycle will be hereinafter referred to as the “length of wire newly fed”. If the length of wire newly fed is d, then d=b_{f}−b_{b}.

In this case, if the ingot 10 is projected onto the wire 50 in a direction in which the ingot 10 is going to be cut, the sum of the lengths of the projected ingot 10 at the multiple cut points is defined to be a maximum total contact length a. For example, as shown in FIG. 3, if the ingot 10 is projected onto the wire 50 in a direction in which the ingot 10 is going to be cut (as indicated by the open bold arrow), the length of a single cut point is supposed to be D′. If the cutting wire web 51n formed by the wire 50 is going to cut the ingot 10 at n points (where n is an integer which is equal to or greater than one), the maximum contact length a between the ingot 10 and the wire 50 is represented by n×D′. If the ingot 10 has a circular cylindrical shape, then D′ is the diameter D of a circle representing a cross section of the ingot. However, the ingot 10 does not always have to have a circular cross section but may also have an elliptical or polygonal cross section as well.

As described above, Patent Document No. 1 teaches running the wire back and forth in a short cycle (i.e., shortening the duration of a run cycle) to reduce waving of the resultant wafers. If the duration of a run cycle of the reciprocating movement is short, it means that the wire's continuous travel distance b is not so much longer than the maximum contact length a between the ingot 10 and the wire 50. The wire's continuous travel distance b is usually a few to ten times as long as the maximum contact length a.

However, the present inventors discovered that the longer the duration of a run cycle, the higher the machining accuracy could be. Specifically, if c1 is set to be b/a, then c1≧20 is suitably satisfied. Also, if c2 is set to be d/a, then 0.35≦c2≦1.55 is suitably satisfied.

The reason will be described below. First of all, if a run cycle in which the wire is run back and forth so that the wire's continuous travel distance becomes twenty or more times as long as the maximum contact length between the ingot and the wire (i.e., so that c1≧20 is satisfied) is carried out a number of times, the wire's work in the entire cutting wire web to contact with the ingot can be reduced and averaged compared to conventional techniques. As a result, waving or warp of a huge number of wafers to be sliced off from the ingot can be reduced. In addition, by setting the length of the wire newly fed in a run cycle to be 0.35 to 1.55 times as long as the maximum contact length (i.e., by setting 0.35≦c2≦1.55), the wire can be kept sharp enough for a long time. As a result, the stress applied to the wire cutting the ingot can be reduced so much that wire snapping will happen much less often while the ingot is being cut. In addition, since waving and warp of the wafers can be reduced, thinner wafers can be sliced off and a greater number of wafers can be sliced off from the ingot. On top of that, since the wafers sliced off are less warped, the time it takes to polish and mirror-polish the wafers before they can be shipped as final products can be shortened as well. Consequently, according to this embodiment, wafers of a high-hardness material can be manufactured at a lower cost than in a conventional process, and the manufacturing process time can be shortened after all. Moreover, by setting the length of the wire newly fed within the range described above, the length of the wire newly fed can be smaller than in a conventional process with the machining accuracy kept sufficiently high. As a result, the length of the wire consumed per wafer can be reduced, and eventually, the cost of using the wire can be cut down as well.

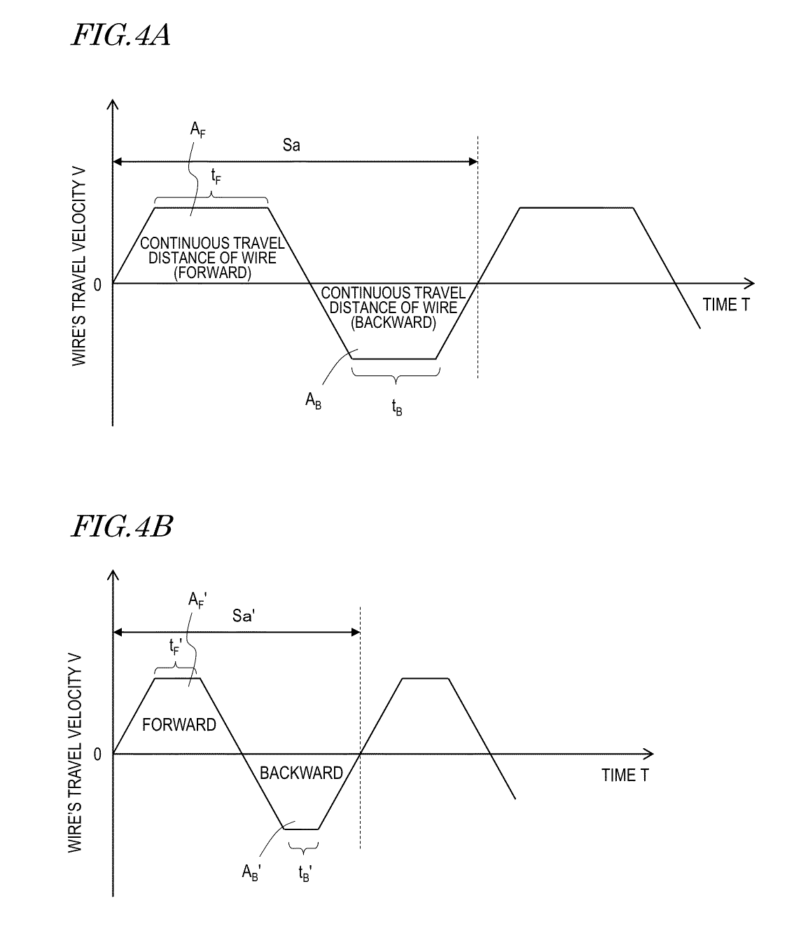

FIG. 4A schematically shows how the travel velocity of the wire 50 changes with time in a method according to this embodiment. In FIG. 4A, the abscissa indicates the amount of time that has passed since the wire 50 started to run, while the ordinate represents the travel velocity V. In the domain in which the ordinate is positive, the wire 50 runs in the forward direction. On the other hand, in the domain in which the ordinate is negative, the wire 50 runs in the backward direction. No matter whether the wire 50 runs in the forward direction or in the backward direction, the wire 50 is accelerated at a rate with the same absolute value to reach a constant velocity, and then decelerated at a rate with the same absolute value. In FIG. 4A, the area of the range A_{F} indicates the travel distance b_{f} of the wire 50 running in the forward direction, and the area of the range A_{B} indicates the travel distance b_{b} of the wire 50 running in the backward direction. By setting the period of time t_{B} for which the velocity is kept constant while the wire 50 is running backward to be shorter than the period of time t_{F} for which the velocity is kept constant while the wire 50 is running forward, the range A_{B} becomes narrower than the range A_{F} and the travel distance in the backward direction becomes shorter. In FIG. 4A, a run cycle period including the forward and backward run periods is indicated by Sa. Also, the difference (A_{F}−A_{B}) between these two ranges A_{B} and A_{F} is the length d of the wire newly fed.

FIG. 4B shows how the travel velocity of the wire 50 for use in a conventional process of cutting an ingot with a multi-wire saw changes with time. Since the periods of time t_{F}′ and t_{B}′ for which the velocity is kept constant in the forward and backward directions are shorter than in this embodiment, the areas of the ranges A_{F}′ and A_{B}′ are narrower than in this embodiment. Consequently, the forward and backward travel distances b_{f}′ and b_{b}′ are shorter than in this embodiment, so are the run cycle period including the forward and backward run periods.

c1 indicates the length of the wire 50 per unit length of the maximum contact length between the ingot and the wire. The longer c1, the longer the length of the wire 50 to be consumed in a run cycle and the lighter the load (i.e., the work) on the wire 50 per unit length.

Meanwhile, c2 indicates the length of the wire newly fed per unit length of the maximum contact length between the ingot and the wire. In the virgin wire 50, the surface of the abrasive particles 61 is covered with the plating layer 62 as shown in FIG. 1C. That is why the degree of sharpness of the abrasive-particle-fixed wire generally changes between (1) an initial state in which the degree of sharpness is still low because the surface of the abrasive particles 61 is covered with the plating layer 62, (2) an intermediate state in which a high degree of sharpness is maintained due to exposure of the abrasive particles 61, and (3) a terminal state in which the degree of sharpness has decreased significantly due to wear or loss of the abrasive particles. Thus, to cut the ingot 10 with high machining accuracy, it is important to maintain the intermediate state in which the degree of sharpness is high enough. This can be said in not just a particular type of wire. For example, even if the abrasive particles have liberated, the wire itself will also be worn to cause snapping easily. That is why the degree of sharpness should also fall within that range in that case. The present inventors discovered via exhaustive experiments that if c2 fell within that range, the wire 50 could be kept sharp enough for a long period of time.

c1 is suitably as long as possible. However, if c1 were too long, the length of the wire 50 consumed in a run cycle would be too long to avoid an increase in cost. Also, if the wire 50 snapped while cutting the ingot 10, then the wire 50 should be tied again. In that case, however, to prevent the knot from breaking the ingot, a part of the wire 50 corresponding to the wire's continuous travel distance b should be replaced. For that reason, if the wire 50 snapped, then the length of the wire 50 to be disposed of would increase. That is why from an economic standpoint, c1 more suitably satisfies 20≦c1≦80. That is to say, the wire's continuous travel distance b is more suitably 20 to 80 times as long as the maximum contact length a.

By setting c1 to be 20≦c1≦80, the work of the wire in the entire cutting wire web 51n in contact with the ingot 10 could be reduced and averaged compared to a conventional process, and waving and warp of a huge number of wafers to be sliced off from the ingot 10 could be reduced, too. On top of that, an economical benefit can also be achieved.

The present inventors further discovered via extensive researches and experiments that the degree of warp of the wafers sliced off would be proportional to the product of the coefficients c1 and c2 described above. Specifically, if c1 is so large that the load per unit length of the wire 50 is light, then c2 may be set to be small. In that case, even if the length of the wire newly fed is short, the machining accuracy can also be kept high. On the other hand, if c1 is so small that the load per unit length of the wire 50 is heavy, then c2 may be set to be large. In that case, the machining accuracy can be kept high by increasing the length of the wire newly fed.

For example, if wafers, of which the diameter is 6 inches, the principal surface is an r-plane, and the thickness is 0.85 μm, have been sliced off from the ingot 10 and should have a warp of 60 μm or less, then c1 and c2 suitably satisfy the following Inequality (1):

30≦c1×c2≦115 (1)

More suitably, c1 and c2 satisfy the following Inequality (2):

50≦c1×c2≦90 (2)

In these inequalities, c1≧20 and 0.35≦c2≦1.55 should be satisfied. Also, in this case, the warp (μm) of a wafer is defined to be the sum of the respective absolute values of the minimum and maximum heights within the wafer's surface in a situation where a reference plane is supposed to be defined by three points which are put at an interval of 120 degrees on a circle that is drawn 3% inside of the wafer's diameter (i.e., a circle defined by 97% of the wafer's radius).

A method of cutting a high-hardness material with a multi-wire saw according to this embodiment can be used to slice off wafers, of which the principal surface has any of various plane orientations, from an ingot of a high-hardness material with any of various plane orientations. If the ingot has a principal surface and at least one cleaved surface other than the principal surface, the wire 50 is suitably run anti-parallel to the intersection between the principal surface and the cleaved surface. As a result, the machining accuracy of the cutting process can be increased by minimizing cleavage as the cutting process with the wire advances. More suitably, the wire 50 is run in such a direction that forms an angle of ±10 degrees with respect to the direction that intersects at right angles with the intersection between the principal surface and the cleaved surface. A situation where the high-hardness material has a hexagonal system crystal structure will be described in detail. In this description, the “hexagonal system crystal structure” refers herein to a crystal structure with a crystal lattice corresponding to c-, m- and r-planes, and includes a hexagonal system crystal structure and other crystal structures which can be approximated to be the hexagonal system crystal structures.

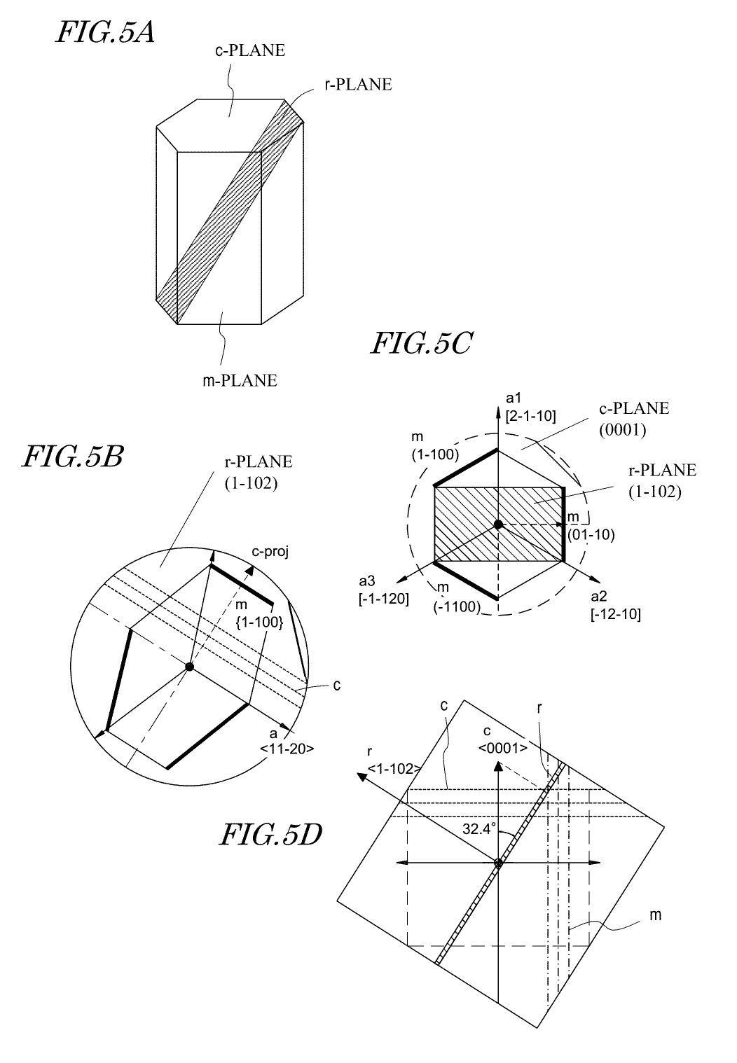

FIG. 5A illustrates the relative arrangement of c-, m- and r-planes in a hexagonal crystal system. A unit cell of a hexagonal system crystal structure has the shape of a hexagonal column, of which the bottom and top faces are c-planes and the side surfaces are m-planes. Also, the r-plane (shadowed in FIG. 5A) is a plane which passes through two opposing sides of a regular hexagon between the two c-planes.

FIG. 5B illustrates the relative arrangement of the c- and m-planes as viewed along a normal to the r-plane. FIG. 5C illustrates the relative arrangement of the r- and m-planes as viewed along a normal to the c-plane. And FIG. 5D illustrates the relative arrangement of the c-, m- and r-planes as viewed parallel to the intersection between the r- and c-planes. Since the r-plane is not parallel to the c-planes or the m-planes, the intersection between the r- and c-planes is present on the r-plane (as indicated by the dotted lines). The intersection is also parallel to the <11-20> directions. As shown in FIG. 5C, the intersections between the m- and c-planes are also present on the c-plane (as indicated by the bold lines).

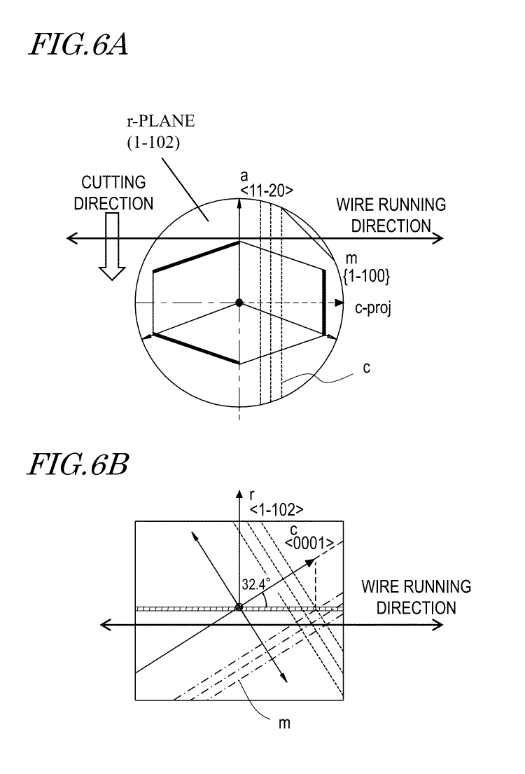

FIG. 6 shows a relation between the direction in which the wire 50 suitably runs and the crystal plane of an ingot in a situation where wafers, of which the principal surface is an r-plane, are being sliced off from the ingot, of which the principal surface is also an r-plane. Specifically, portion A of FIG. 6 shows their relation as viewed from the r-plane, while portion B of FIG. 6 shows their relation as viewed along a normal to the r-plane.

In a hexagonal system crystal structure, the c- and m-planes are surfaces to be cleaved easily. That is why in slicing off wafers, of which the principal surface is an r-plane, from an ingot of a hexagonal system high-hardness material, the wire is suitably run anti-parallel to either the intersection between the principal surface and the c-plane or the intersection between the principal surface and the m-plane to reduce the influence of cleavage. In that case, the direction in which the ingot is going to be cut is not perpendicular to either the intersection between the principal surface and the c-plane or the intersection between the principal surface and the m-plane. More suitably, the wire is run in such a direction that forms an angle of within ±10 degrees with respect to the direction that intersects at right angles with the intersection between the r- and c-planes (or the r- and m-planes). Also, the direction in which the ingot is going to be cut suitably forms an angle of within ±5 degrees with respect to the intersection between the r- and c-planes (or the r- and m-planes). By running the wire 50 in such a direction, waving of the wire can be minimized and the wire snapping and the warp of the wafers sliced off can be reduced significantly.

The principal surface of those wafers to be sliced off by the cutting method of this embodiment does not have to be an r-plane. For example, the cutting method of this embodiment can also be used effectively to slice off wafers, of which the principal surface is either a c-plane or a plane that defines a tilt angle (also called an “off-axis angle”) of within ±10 degrees with respect to a normal to the c-plane, from an ingot of which the principal surface is a c-plane. In that case, the wire may also be run in a direction which forms an angle of within ±10 degrees with respect to the direction that intersects at right angles with either the intersection between the c-plane and the m-plane or the intersection between the principal surface that defines a tilt angle (also called an “off-axis angle”) of within ±10 degrees with respect to a normal to the c-plane and the m-plane. Furthermore, the direction in which the ingot is going to be cut may also be set to form an angle of within ±5 degrees with respect to either the intersection between the c-plane and the m-plane or the intersection between the principal surface that defines a tilt angle of within ±10 degrees with respect to a normal to the c-plane and the m-plane.

### EXAMPLES

The present inventors carried out some experimental examples in which an ingot of a high-hardness material was sliced by the cutting method of this embodiment to find how much warp the wafers thus sliced off had. The results will be described below.

As an ingot of a high-hardness material, an ingot of single crystal sapphire in the shape of a circular cylinder with a diameter of 150 mm (i.e., 6 inches) was provided so as to slice off wafers, of which the principal surface was an r-plane. The ingot was cut using the following multi-wire saw, abrasive-particle-fixed wire and abrasive slurry:

Multi-wire saw: multi-wire saw MWS-34 produced by Takatori Corporation;
Wire: diamond-electrodeposited wire produced by Allied Material (A. L. M. T. Corp.) and having a wire diameter of 180 μm and an average abrasive particle size of 35 μm; and
Abrasive Slurry: DKW-2 produced by Allied Material (A. L. M. T. Corp.)

The ingot was sliced into wafers representing Examples #1 through #8 and Comparative Examples #1 through #6 with the thickness of the wafers to be sliced off, the maximum contact length a between the ingot and the wire, the continuous travel distance b and the length of the wire newly fed set to be the values shown in the following table. Other conditions are as follows:
Cutting/slicing rate: 0.06 mm/min;
Wire running speed (maximum): 400 m/min;
Wire running speed acceleration rate: ±3.3/sect; and
Wire running direction: perpendicular direction which is non-parallel to the intersection between r- and c-planes in a situation where the principal surface of wafers sliced off is r-plane (the direction indicated by the open bold arrow in portion A of FIG. 6).

The machining accuracy of the wafers sliced off was evaluated by their warp (μm). Using a machine FM200XRA produced by Corning Tropel, the warp (μm) was defined to be the sum of the respective absolute values of the minimum and maximum heights within each wafer's surface in a situation where a reference plane was supposed to be defined by three points which were put at an interval of 120 degrees on a circle that was drawn 3% inside of the wafer's diameter (i.e., a circle defined by 97% of the wafer's radius), and the average was calculated between all of those wafers sliced off.

The results are summarized in the following Table 1, in which also shown are the c1 (=b/a), c2 (=d/a) and c1×c2 values and the length of the wire consumed per wafer that were calculated.

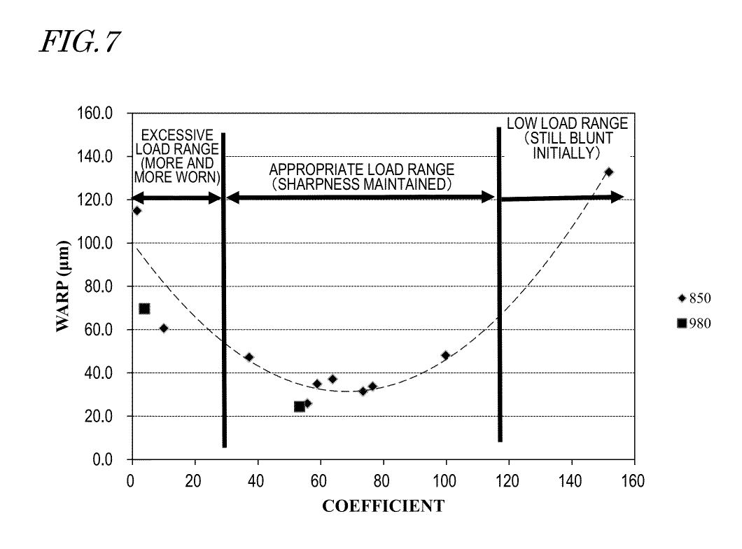

Also, a graph concerning the thicknesses of the wafers sliced off was drawn with the c1×c2 values plotted as abscissas and with the warp of the wafers plotted as ordinates. The results are shown in FIG. 7.

TABLE 1

| | | Maximum | | | | | | | Length of |
|---|---|---|---|---|---|---|---|---|---|
| | Wafer's | contact | Continuous | | Length of | | | | wire |
| | thickness | length a | travel distance | c1 | wire newly | c2 | | Warp | consumed |
| Sample | (mm) | (m) | (m) | (b/a) | fed d (m) | (d/a) | c1 × c2 | (μm) | (m/wafer) |
| Ex. 1 | 0.98 | 6.6 | 386 | 58 | 6.0 | 0.91 | 53 | 24 | 185 |
| Ex. 2 | 0.85 | 6.5 | 386 | 59 | 6.0 | 0.92 | 55 | 25 | 185 |
| Ex. 3 | 0.85 | 6.5 | 386 | 59 | 4.0 | 0.62 | 37 | 47 | 123 |
| Ex. 4 | 0.85 | 8.3 | 513 | 62 | 9.7 | 1.17 | 72 | 31 | 181 |
| Ex. 5 | 0.85 | 10.7 | 680 | 64 | 16.6 | 1.55 | 99 | 48 | 181 |
| Ex. 6 | 0.85 | 5.3 | 513 | 97 | 3.2 | 0.60 | 58 | 35 | 93 |
| Ex. 7 | 0.85 | 6.9 | 766 | 111 | 4.8 | 0.70 | 77 | 33 | 90 |
| Ex. 8 | 0.85 | 15.2 | 1025 | 67 | 14.3 | 0.94 | 63 | 37 | 92 |
| Cmp. | 0.98 | 5.1 | 86 | 17 | 1.2 | 0.24 | 4 | 69 | 185 |
| Ex. 1 | | | | | | | | | |
| Cmp. | 1.25 | 6.2 | 86 | 14 | 1.3 | 0.21 | 3 | 67 | 163 |
| Ex. 2 | | | | | | | | | |
| Cmp. | 1.25 | 8.1 | 86 | 11 | 1.8 | 0.22 | 2 | 109 | 182 |
| Ex. 3 | | | | | | | | | |
| Cmp. | 0.85 | 2.6 | 86 | 33 | 0.8 | 0.31 | 10 | 61 | 251 |
| Ex. 4 | | | | | | | | | |
| Cmp. | 0.85 | 6.6 | 86 | 13 | 0.8 | 0.12 | 2 | 114 | 94 |
| Ex. 5 | | | | | | | | | |
| Cmp. | 0.85 | 7.1 | 680 | 96 | 11.1 | 1.56 | 150 | 132 | 185 |
| Ex. 6 | | | | | | | | | |

As can be seen from Table 1, in Examples #1 through #8 in which c1 was set to be equal to or greater than 20 and c2 was set to fall within the range of 0.35 to 1.55, the wafers had a warp of 60 μm or less. In these examples, c1×c2 was within the range defined by Inequality (1). Among other things, in Examples #1, #2, #4, #6 and #7 in which Inequality (2) was satisfied, the wafers had a warp of 40 μm or less.

On the other hand, in Comparative Examples #1 through #6 in which c1 was less than 20 and c2 was either less than 0.35 or more than 1.55, the wafers had a warp of greater than 60 μm. Among other things, the results obtained in Comparative Examples #1 to #4 reveal that when the c1 value was small (under a conventional cutting condition), the wafers warped significantly. Also, as can be seen from the results obtained in Comparative Example #6, even if c1 was equal to or greater than 20 but if c2 was greater than 1.55, the wafers had a warp of more than 60 μm. These results were obtained probably because the virgin part of the wire had its surface coated with a plating layer, for example, and had so low a degree of sharpness in the initial state that the warp of the wafers was significantly affected by the initial state of the virgin part of the wire when the length of the wire newly fed was long.

As shown in FIG. 7, the wafers had the smallest warp when the c1×c2 value was approximately equal to 70, and the wafers' warp should increase, no matter whether the c1×c2 value was greater than, or less than, 70. Specifically, no matter whether the c1×C2 value was less than 30 or greater than 115, the wafers' warp was more than 60 μm. This is probably because if the c1×c2 value was less than 30, the ingot would have been cut in either a state where the length of the wire 50 per unit length of the ingot in contact with the wire 50 was so short that the load per unit length of the wire 50 was excessive or a terminal state where the length of the wire newly fed was too short to keep the wire 50 sharp enough. On the other hand, if the c1×c2 value was greater than 115, the ingot would have been cut in the initial state where the length of the wire newly fed was too long to make the wire 50 sharp enough as described above.

As shown in Table 1, the length of the wire consumed per wafer was about 185 in each of Examples #1, #2 and #5 and Comparative Examples #1, #3 and #6. These results reveal that even if the length of the wire consumed is the same, wafers with different degrees of warp can be sliced off by changing the cutting condition.

Also, in Examples #6 to #8, the length of the wire consumed was as small as about 90. That is why it can be seen that to cut down the cost of the wire used, c1 suitably falls within the range of 65 to 115 and c2 suitably falls within the range of 0.6 to 1.

Next, with the thickness of the wafers to be sliced off set to be 850 μm, an ingot of sapphire with a hexagonal system crystal structure was pushed against a wire running perpendicularly to the intersection between r- and c-planes, thereby slicing the ingot into wafers, of which the principal surface would be an r-plane. And the warp of the wafers thus sliced off was evaluated as shown in the following Table 2. The number of times of wire snapping that happened during the cutting process is also shown in Table 2. The conditions not shown in Table 2 are the same as in Examples #1 through #8.

TABLE 2

| | | | Continuous | | | | | | Length of | |
|---|---|---|---|---|---|---|---|---|---|---|
| | | Maximum | travel | | Length of | | | | wire | |
| | Wire running | contact | distance | C1 | wire newly | C2 | | Warp | consumed | Wire |
| Sample | direction | length a (m) | (m) | (b/a) | fed d (m) | (d/a, %) | c1 × c2 | (μm) | (m/wafer) | snapping |
| Ex. 21 | Perpendicular | 6.5 | 386 | 59 | 6.0 | 0.92 | 55 | 25 | 185 | NO |
| | to intersection | | | | | | | | | |
| | between r- and | | | | | | | | | |
| | c-planes | | | | | | | | | |

As shown in Table 2, in slicing off wafers so that their principal surface would be an r-plane, in Example #21 in which the wire was run perpendicularly to the intersection between r- and c-planes, c1 was equal to or greater than 20, c2 was in the range of 0.35 to 1.55, and therefore, the wafers had a warp of 60 μm or less. In this case, the direction in which the ingot was going to be cut was parallel to the intersection between r- and c-planes.

A method of cutting a high-hardness material with a multi-wire saw according to the present disclosure can be used effectively to cut an ingot of a high-hardness material which has been made to have any of various sizes by any of various crystal growing methods.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2014-006791 filed on Jan. 17, 2014 the entire contents of which are hereby incorporated by reference.

What is claimed is:

1. A method of cutting a high-hardness material with a multi-wire saw, in which an ingot of the high-hardness material is sliced into a plurality of wafers by cutting the ingot at multiple points simultaneously with the multi-wire saw,
wherein the method comprises repeating a run cycle of reciprocating motion of a wire of the multi-wire saw so that following relationships are satisfied:
c1≧20, given C1=b/a,
where
a is a maximum total contact length defined as a sum of the lengths of the ingot as projected onto multiple cut points when projecting the ingot onto the wire in a direction in which the ingot is going to be cut, and
b is a continuous travel distance of the wire; and
0.35≦c2≦1.55, given c2=d/a,
where
d is a length of the wire newly fed in each said run cycle.

2. The method of claim 1, wherein the run cycle is repeated so that the following Inequality is satisfied:
20≦c1≦80.

3. The method of claim 1, wherein the run cycle is repeated so that the following Inequalities are satisfied:
65≦c1≦115 and
0.6≦c2≦1.

4. The method of claim 1, wherein c1 and c2 satisfy the following relation:
30≦c1×c2≦115.

5. The method of claim 4, wherein c1 and c2 satisfy the flowing relation:
50≦c1×c2≦90.

6. The method of claim 1, wherein super abrasive particles are fixed on the wire by electrodeposition.

7. The method of claim 1, wherein the high-hardness material has a Vickers hardness of 1500 or more.

8. The method of claim 1, wherein the high-hardness material is selected from the group consisting of silicon carbide, sapphire, gallium nitride, aluminum nitride, diamond, boron nitride, zinc oxide, gallium oxide and titanium dioxide.

9. The method of claim 1, wherein the crystal lattice of the ingot has at least one cleaved face, the wafers sliced off from the ingot each have a principal surface, and
the wire is run in a direction which is non-parallel to an intersection between the principal surface and the cleaved face.

10. The method of claim 9, wherein the high-hardness material has a hexagonal system crystal structure, the ingot's principal surface is an r-plane, and the at least one cleaved face is a c-plane.

11. The method of claim 9, wherein the high-hardness material is sapphire, the principal surface is a c-plane, and the at least one cleaved face is an m-plane.
